(19) United States
(12) Patent Application Publication
(10) Pub. No.: US 2019/0315333 A1
(43) Pub. Date: Oct. 17, 2019

(54) CONTROL DEVICE FOR HYBRID VEHICLE

(71) Applicant: TOYOTA JIDOSHA KABUSHIKI KAISHA, Toyota-shi (JP)

(72) Inventors: Hideki NAKAZONO, Susono-shi (JP); Teruhiko Sonoda, Toyota-shi (JP)

(73) Assignee: TOYOTA JIDOSHA KABUSHIKI KAISHA, Toyota-shi (JP)

(21) Appl. No.: 16/380,043

(22) Filed: Apr. 10, 2019

(30) Foreign Application Priority Data
Apr. 13, 2018 (JP) 2018-077331

(51) Int. Cl. B60W 20/00

(52) U.S. Cl. CPC B60W 20/00; B60W 2540/10; B60K 6/20; B60W 2510/244; B60W 2710/06

(57) ABSTRACT

A control device for a hybrid vehicle, the control device including: a controller performing control on an engine operating point along an equal power curve when a target charge amount of a battery exceeds an upper limit value of a battery charge power due to a further depressing of an accelerator pedal. Further, when a ratio of a noise derived from a powertrain of the hybrid vehicle to all noises is less than a ratio of a background noise to the all noises, or when a deceleration is requested, the controller returns the engine operating point from an engine operating point on the equal power curve to an engine operating point within an operating region where power generation efficiency is high.

### CROSS-REFERENCE TO RELATED APPLICATION(S)

The present application claims priority to and incorporates by reference the entire contents of Japanese Patent Application No. 2018-077331 filed in Japan on Apr. 13, 2018.

### BACKGROUND

The present disclosure relates to a control device for a hybrid vehicle.

Japanese Laid-open Patent Publication No. 2013-075547 describes a control device for a hybrid vehicle that provides both a feeling of acceleration due to a change in engine rotation speed and an improvement in power generation efficiency. Specifically, when a state of charge (SOC) of a battery is equal to or greater than a predetermined value, the control device described in Japanese Laid-open Patent Publication No. 2013-075547 controls the engine rotation speed and the output torque based on how much an accelerator pedal is operated, and controls an engine operating point in a first operating region where the power generation efficiency is equal to or greater than the predetermined value. On the other hand, when the state of charge of the battery is less than the predetermined value, the control device described in Japanese Laid-open Patent Publication No. 2013-075547 controls the engine operating point in a second operating region where power generated by a generator motor is greater than that in the first operating region.

In the control device described in Japanese Laid-open Patent Publication No. 2013-075547, when the charge power Win of the battery is limited, the engine operating point is controlled along an equal power curve so as to secure a feeling of acceleration. However, in this case, when the engine operating point is returned to an engine operating point within the first operating region with high power generation efficiency after acceleration, engine sound is reduced, which may give a strange feeling to a driver.

### SUMMARY

There is a need for providing a control device for a hybrid vehicle which prevents giving a strange feeling to a driver when an engine operating point is returned from an engine operating point on an equal power curve to an engine operating point within an operating region with high power generation efficiency.

According to an embodiment, a control device for a hybrid vehicle, the control device includes: a controller performing control on an engine operating point along an equal power curve when a target charge amount of a battery exceeds an upper limit value of a battery charge power due to a further depressing of an accelerator pedal. Further, when a ratio of a noise derived from a powertrain of the hybrid vehicle to all noises is less than a ratio of a background noise to the all noises, or when a deceleration is requested, the controller returns the engine operating point from an engine operating point on the equal power curve to an engine operating point within an operating region where power generation efficiency is high.

### BRIEF DESCRIPTION OF THE DRAWINGS

FIG. 1 is a diagram schematically illustrating an example configuration of a hybrid vehicle including a control device according to an embodiment of the present disclosure;

FIG. 2 is a flowchart of an engine operating point control process according to an embodiment of the present disclosure;

FIG. 3 is a graph illustrating a relationship between an engine rotation speed and an output torque in the engine operating point control process;

FIG. 4 is a graph illustrating an example relationship between a further depressing amount of an accelerator pedal and an engine rotation speed increase expectation value;

FIG. 5 is a flowchart of an engine operating point return process according to an embodiment of the present disclosure;

FIG. 6 is a graph illustrating an example of a relationship between a vehicle speed and a sound pressure of powertrain noise in an EV drive and an ENG drive; and

FIG. 7 is a graph illustrating a relationship between a vehicle speed and an acoustic power ratio of a noise generated by a power generation unit.

### DETAILED DESCRIPTION

With reference to the accompanied drawings, hereinafter described are an example configuration and an operation of a control device according to an embodiment of the present disclosure for a hybrid vehicle.

Configuration of Hybrid Vehicle

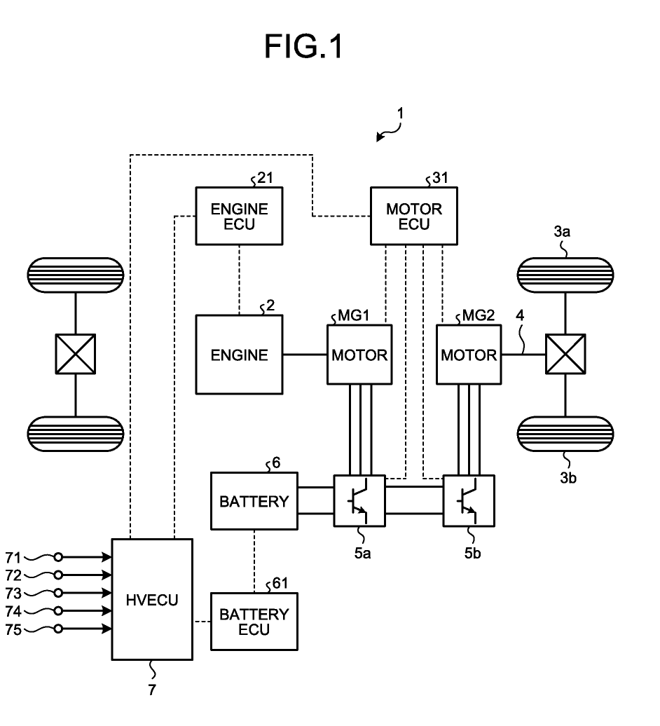

With reference to FIG. 1, a configuration and an operation of a hybrid vehicle to which a control device according to an embodiment of the present disclosure for the hybrid vehicle is applied.

FIG. 1 is a diagram schematically illustrating an example configuration of the hybrid vehicle to which the control device according to the embodiment of the present disclosure for the hybrid vehicle is applied. As illustrated in FIG. 1, a hybrid vehicle 1 to which the control device according to the embodiment of the present disclosure for the hybrid vehicle is applied is what is called a series hybrid vehicle, which including a motor (generator motor) MG1 for power generation and a motor (drive motor) MG2 for driving. The motor MG1 is connected to an output shaft of an engine 2, and the motor MG2 is connected to a drive shaft 4 coupled to drive wheels 3a and 3b. Specifically, the hybrid vehicle 1 includes the engine 2, the generator motor MG1, the drive motor MG2, inverters 5a and 5b, a battery 6, and a Hybrid Vehicle Electronic Control Unit (hereinafter referred to as an “HVECU”) 7 as main components thereof.

The engine 2 is an internal combustion engine that outputs power, using a fuel such as gasoline and light oil. An operation of the engine 2 is controlled by an engine Electronic Control Unit (hereinafter referred to as an “engine ECU”) 21. The engine ECU 21 includes a microprocessor, and includes, for example, a Central Processing Unit (CPU), a Read Only Memory (ROM) for storing a control program, a Random Access Memory (RAM) for temporarily storing data, input and output ports, and communication ports. The engine ECU 21 is connected to the HVECU 7 through the communication port.

The generator motor MG1 is a synchronous motor generator, and a rotor thereof is connected to the output shaft of the engine 2. The drive motor MG2 includes a synchronous motor generator, and a rotor thereof is connected to the drive shaft 4. The inverters 5a and 5b are connected to the motor generator MG1 and the drive motor MG2, respectively, and are also connected to the battery 6 through power lines. The motor generator MG1 and the drive motor MG2 are rotationally driven when a motor electronic control unit (hereinafter referred to as a “motor ECU”) 31 performs switching control on a plurality of switching elements included in the inverters 5a and 5b. The motor ECU 31 includes a microprocessor similar to the engine ECU 21. The motor ECU 31 is connected to the HVECU 7 through the communication port.

The battery 6 is a lithium ion secondary battery or a nickel hydrogen secondary battery and is connected to the inverters 5a and 5b through the power lines. The battery 6 is controlled by a battery Electronic Control Unit (hereinafter referred to as a “battery ECU”) 61. The battery ECU 61 includes a microprocessor similar to the engine ECU 21. The battery ECU 61 is connected to the HVECU 7 through the communication port.

The HVECU 7 includes a microprocessor similar to the engine ECU 21. Signals from various sensors are input to the HVECU 7 through input ports. Examples of the signals input to the HVECU 7 include an ignition signal from an ignition switch 71, an engine rotation speed signal from an engine rotation speed sensor 72 which detects a rotating speed of the engine 2, an accelerator position signal from an accelerator pedal position sensor 73 which detects how much an accelerator pedal is depressed, a brake pedal position signal from a brake pedal position sensor 74 that detects how much a brake pedal is depressed, and a vehicle speed signal from a vehicle speed sensor 75. The HVECU 7 is connected to the engine ECU 21, the motor ECU 31, and the battery ECU 61 through the communication ports.

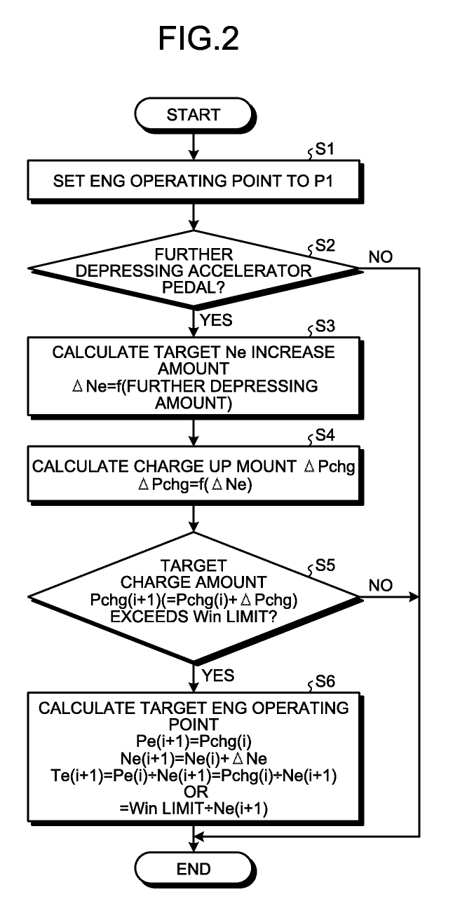

In the hybrid vehicle 1 with such a configuration, in response to further depressing operation of the accelerator pedal, the HVECU 7 increases an engine rotation speed while increasing a power generation amount on an optimum efficiency line. However, when a battery charge power Win is limited due to low temperature or a high SOC of the battery 6, for example, even though the HVECU 7 attempts to increase the engine rotation speed while increasing the power generation amount, it is difficult to increase the engine rotation speed to an intended amount due to the limited the battery charge power Win. This may give a strange feeling to a driver. Accordingly, in this embodiment, the HVECU 7 performs the following engine operating point control process which avoids the limitation of the battery charge power Win and increases the engine rotation speed. With reference to FIGS. 2 to 4, an operation of the HVECU 7 during the engine operating point control process is described.

Engine Operating Point Control Process

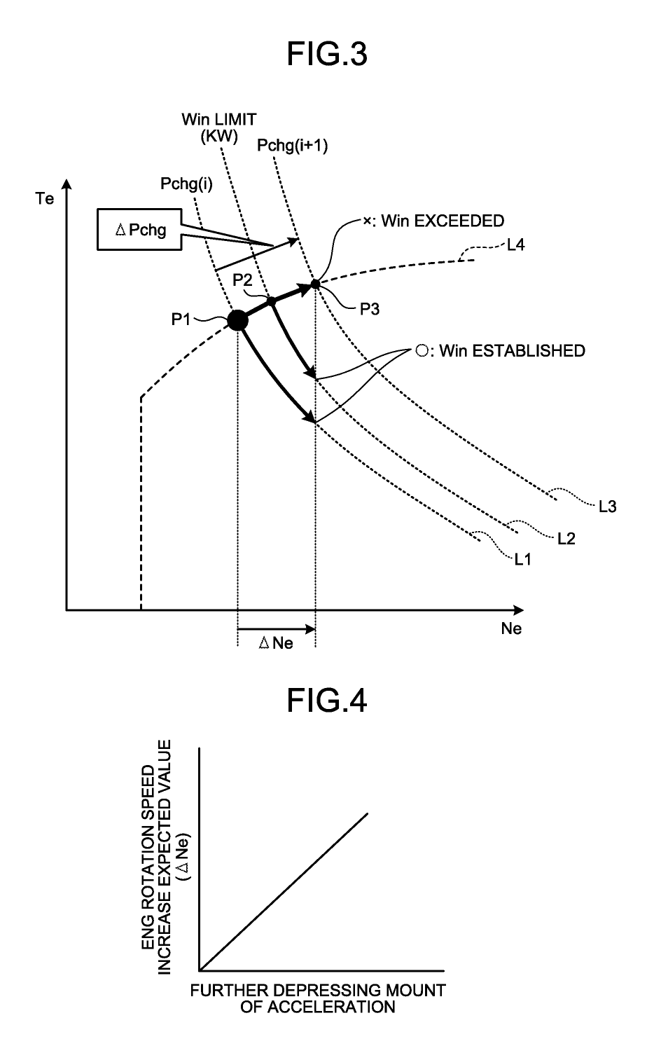

FIG. 2 is a flowchart of the engine operating point control process according to an embodiment of the present disclosure. FIG. 3 is a graph illustrating a relationship between the engine rotation speed and an output torque in the engine operating point control process. FIG. 4 is a graph illustrating an example relationship between a further depressing amount of the accelerator pedal and an engine rotation speed increase expectation value.

The flowchart of FIG. 2 starts when the ignition switch of the hybrid vehicle 1 is changed from the off state to the on state, and the engine operating point control process goes to Step S1. The engine operating point control process is repeatedly performed at predetermined control intervals while the ignition switch is in the on state.

In Step S1, the HVECU 7 controls so that the engine (ENG) operating point is to be set to a fixed operating point P1 (see FIG. 3), which is on an optimum efficiency line L4 (see FIG. 3) with respect to the entire components (i.e., the engine 2, the generator motor MG1, the drive motor MG2, the inverters 5a and 5b, and the like) in a power generation unit. Herein, the symbol “Pchg(i)” represents a target charge amount of the battery 6 at the fixed operating point (a fixed operating point specific to series control) P1, the symbol “Ne(i)” represents the rotation speed of the engine 2, and the symbol “Te(i)” represents the output torque of the engine 2. Note that “i” indicates the timing of control. Accordingly, Step S1 ends, and the engine operating point control process goes to Step S2.

In Step S2, based on the accelerator position signal from the accelerator pedal position sensor 73, the HVECU 7 determines whether the driver is further depressing the accelerator pedal based on the accelerator position signal from the accelerator pedal position sensor 73. When determining that the driver is further depressing the accelerator pedal (YES in Step S2), the HVECU 7 proceeds the engine operating point control process to Step S3. On the other hand, when determining that the driver is not re-depressing the accelerator pedal (NO in Step S2), the HVECU 7 ends a series of engine operating point control process.

In Step S3, based on a table, as illustrated in FIG. 4, which indicates a relationship between the further depressing amount of the accelerator pedal and an increase expected value of the rotation speed of the engine 2 (ENG rotation speed increase expected value) ΔNe, the HVECU 7 reads out data of the ENG rotation speed increase expected value ΔNe, which corresponds to the further depressing amount of the accelerator pedal detected in Step S2. Then, the HVECU 7 sets the read ENG rotation speed increase expected value ΔNe to a target increase amount of the rotation speed of the engine 2 (target Ne increase amount) ΔNe. By doing this, Step S3 end, and the engine operating point control process goes to Step S4.

In Step S4, based on a table indicating a relationship between the target Ne increase amount ΔNe and an increase amount of a charge amount of the battery 6 (charge UP amount) ΔPchg, the HVECU 7 reads out data the charge UP amount ΔPchg, which corresponds to the target Ne increase amount ΔNe set in Step S3. By doing this, Step S4 ends, and the engine operating point control process goes to Step S5.

In Step S5, the HVECU 7 calculates a value by adding the charge UP amount ΔPchg, which is read out in step S4, to a target charge amount Pchg(i) of the battery 6 in current status as a target charge amount Pchg(i+1) of the battery 6. The HVECU 7 then determines whether the target charge amount Pchg(i+1) of the battery 6 exceeds an upper limit (Win limit) of the charge power Win of the battery 6. When determining that the target charge amount Pchg(i+1) of the battery 6 exceeds the Win limit (YES in Step S5, for example, a point P3 illustrated in FIG. 3), the HVECU 7 proceeds the engine operating point control process to Step S6. On the other hand, when determining that the target charge amount Pchg(i+1) of the battery 6 does not exceed the Win limit (NO in Step S5), the HVECU 7 ends the series of engine operating point control process.

In Step S6, the HVECU 7 increases the engine rotation speed Ne by controlling the engine operating point along equal power curves L1 to L3 illustrated in FIG. 3. Specifically, the HVECU 7 sets an engine required output Pe(i+1) to the target charge amount Pchg(i) in the current state, and further sets an engine rotation speed Ne(i+1) to a value obtained by adding the target Ne increase amount ΔNe to the engine rotation speed Ne(i) in the current state. Furthermore, the HVECU 7 calculates a value obtained by dividing a engine required output Pe(i) in the current state, the target charge amount Pchg(i), or the Win limit by the engine rotation speed Ne(i+1), and sets the calculated value as an engine output torque Te(i+1). Note than the HVECU 7 may start the control of the engine operating point along the equal power curve at the timing when the target charge amount Pchg(i+1) of the battery 6 is expected to exceed the Win limit like, for example, the control along the equal power curve L1. Alternatively, the HVECU 7 may start the control of the engine operating point along the equal power curve at the timing when the target charge amount Pchg(i+1) of the battery 6 is expected to reach the Win limit like, for example, the control along the equal power line L2. By doing this, Step S6 ends, and the series of the engine operating point control process ends.

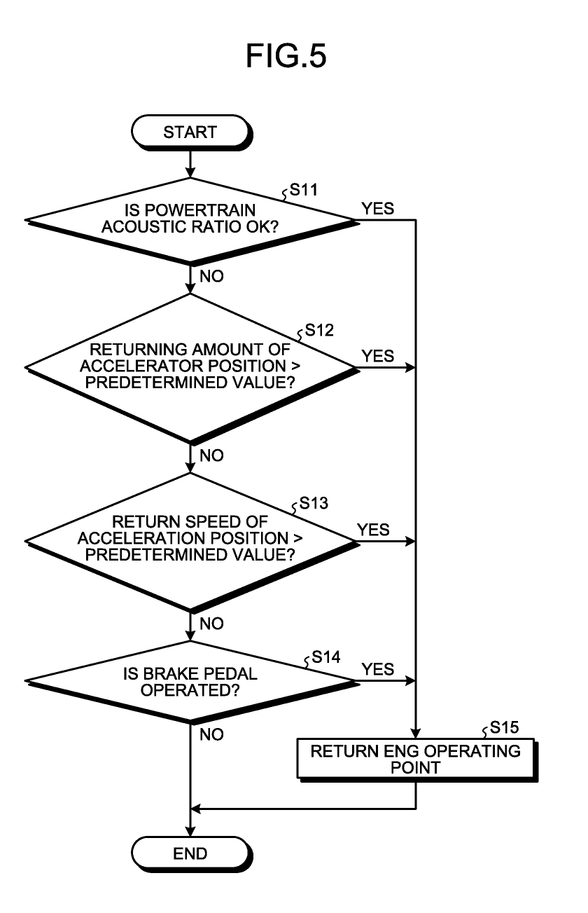

However, as described above, along with the further depressing operation of the accelerator pedal, in a case where the target charge amount of the battery 6 exceeds the upper limit of the charge power Win of the battery 6, when the engine operating point is controlled along the equal power curve, if, after acceleration, the engine operating point is returned to an engine operating point within an operating region where power generation efficiency is high, engine sound is decreased. This may give a strange feeling to the driver. To address the problem, according to this embodiment, the HVECU 7 executes the following engine operating point return process to prevent the driver from feeling of strangeness when the engine operating point is returned, after acceleration, to the engine operating point within the operating region where power generation efficiency is high. With reference to FIGS. 5 to 7, an operation of the HVECU 7 during the engine operating point return process is described.

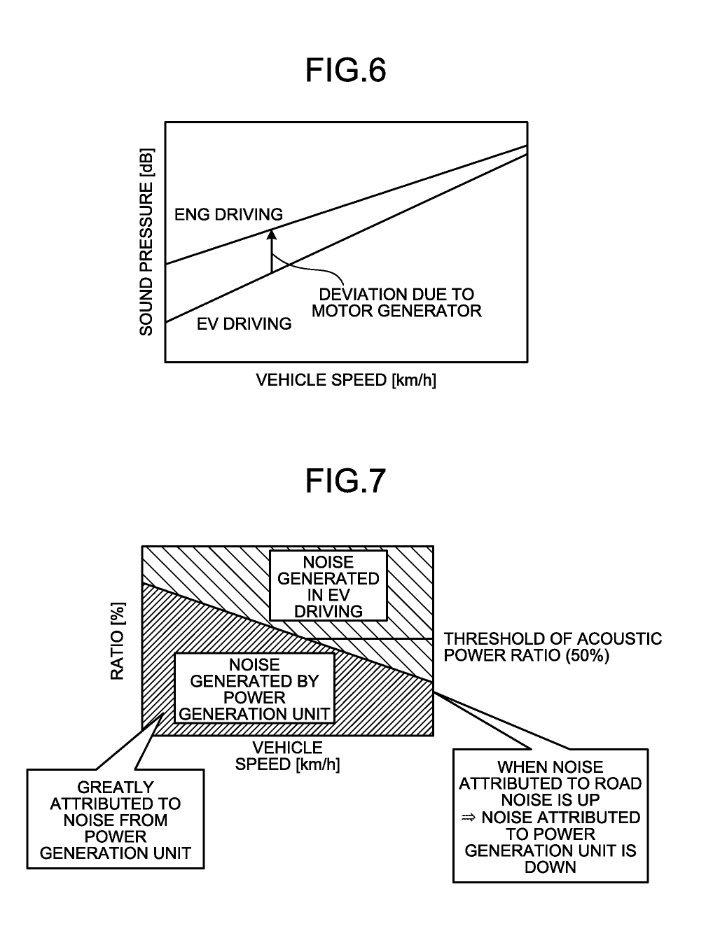

FIG. 5 is a flowchart of the engine operating point return process according to an embodiment of the present disclosure. FIG. 6 is a graph illustrating an example relationship between a vehicle speed and a sound pressure of powertrain noise during EV driving and a ENG driving. FIG. 7 is a graph illustrating a relationship between a vehicle speed and an acoustic power ratio of noise generated by the power generation unit.

The flowchart of FIG. 5 starts at the timing when the process of controlling the engine operating point along the equal power curve starts, and the engine operating point return process goes to Step S11. The engine operating point return process is repeatedly performed at predetermined control intervals while the process of controlling the engine operating point along the equal power curve is performed.

In Step S11, the HVECU 7 determines whether an acoustic power ratio (powertrain acoustic ratio) of noise (powertrain noise) derived from the power generation unit is less than a predetermined acoustic power ratio determination threshold value (for example, 50%). Specifically, as illustrated in FIG. 6, the sound pressure of the powertrain noise differs between EV driving and ENG driving by an amount of noise derived from the power generation unit (generator). Accordingly, a relationship, as illustrated in FIG. 6, between a vehicle speed and a sound pressure of the powertrain noise in both EV driving and ENG driving is obtained in advance by an experiment, and an acoustic power ratio of each noise is analyzed based on the relationship obtained by the experiment. This makes it possible to obtain a relationship between a vehicle speed and an acoustic power ratio of a power generation unit generation noise generated by the power generation unit (powertrain noise) as illustrated in FIG. 7.

In the example of FIG. 7, when the vehicle speed is low, the acoustic power ratio of the power generation unit generation noise is greater than the acoustic power ratio of the generation noise generated in EV driving (background noise (by such as tire, wind noise, and audio)). Further, with an increase in vehicle speed, the acoustic power ratio of the power generation unit generation noise becomes less than the acoustic power ratio of the noise generated in EV driving. Therefore, the HVECU 7 detects a current vehicle speed and determines whether the acoustic power ratio of the power generation unit generation noise (powertrain noise) corresponding to the detected vehicle speed is less than the predetermined acoustic power ratio determination threshold value (for example, 50%) corresponding to the acoustic power ratio of the noise generated by driving in EV driving.

When determining that the acoustic power ratio of the powertrain noise is less than the predetermined acoustic power ratio determination threshold value (YES in Step S11), the HVECU 7 determines that the powertrain noise is masked by the background noise and that it is difficult to notice the change in engine sound. Then, the HVECU 7 proceeds the engine operating point return process to Step S15. On the other hand, when determining that the powertrain acoustic ratio is equal to or more than the predetermined threshold for determining the acoustic power ratio (NO in Step S11), the HVECU 7 proceeds the engine operating point return process to Step S12.

In Step S12, the HVECU 7 determines whether a returning amount of an accelerator position is equal to or greater than a predetermined value. When determining that the returning amount of the accelerator position is equal to or greater than the predetermined value (YES in Step S12), the HVECU 7 determines that a feeling of strangeness is alleviated by the deceleration request, and the HVECU 7 proceeds the engine operating point return process to Step S15. On the other hand, when determining that the returning amount of the accelerator position is less than the predetermined value (NO in Step S12), the HVECU 7 proceeds the engine operating point return process to Step S13.

In Step S13, the HVECU 7 determines whether a return speed of the accelerator position is equal to or greater than a predetermined value. When determining that the return speed of the accelerator position is equal to or greater than the predetermined value (YES in Step S13), the HVECU 7 determines that a feeling of strangeness is alleviated by the deceleration request, and the HVECU 7 proceeds the engine operating point return process to Step S15. On the other hand, when determining that the return speed of the accelerator position is less than the predetermined value (NO in Step S13), the HVECU 7 proceeds the engine operating point return process to Step S14.

In Step S14, the HVECU 7 determines whether the brake pedal is operated. When determining that the brake pedal is operated (YES in Step S14), the HVECU 7 determines that a feeling of strangeness is alleviated by the deceleration request, and the HVECU 7 proceeds the engine operating point return process to Step S15. On the other hand, when determining that the brake pedal is not operated (NO in Step S14), the HVECU 7 ends the series of engine operating point return process.

In Step S15, the HVECU 7 returns the engine operating point from an engine operating point on the equal power curve to an engine operating point within the region where power generation efficiency is high. by doing this, Step S15 is completed, and the series of the engine operating point return process ends.

As obvious from the above description, in the engine operating point return process according to an embodiment of the present disclosure, when a ratio of noise of all kinds of noise which is derived from the powertrain of the hybrid vehicle 1 is lower than a ratio of background noise of the all kinds of noise, or when deceleration is requested, the HVECU 7 returns the engine operating point from an engine operating point on the equal power curve to an engine operating point within the operating region where high power generation efficiency is high. Thus, it is possible to prevent a feeling of strangeness given to a driver when the engine operating point is returned from the engine operating point on the equal power curve to the engine operating point within the operating region where power generation efficiency is high.

Hereinbefore, an embodiment is described to which the present disclosure discovered by the inventors is applied, but it should be noted that the present disclosure is not limited by the descriptions and drawings which represent a part of the disclosure of the present disclosure according to this embodiment. In other words, other embodiments, examples, and techniques employed by those skilled in the art based on this embodiment are all included in the scope of the present disclosure.

in a control device according to the present disclosure for a hybrid vehicle, when a ratio of noise derived from a powertrain of the hybrid vehicle to noise of all kinds of noise is lower than a ratio of background noise to the noise of the all kinds of noise, or when deceleration is requested, an engine operating point is returned from an engine operating point on an equal power curve to an engine operating point within an operating region where power generation efficiency is high. Thus, it is possible to prevent a feeling of strangeness given to a driver when the engine operating point is returned from the engine operating point on the equal power curve to the engine operating point within the operating region where power generation efficiency is high.

Although the disclosure has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A control device for a hybrid vehicle, the control device comprising:
a controller configured to perform control on an engine operating point along an equal power curve when a target charge amount of a battery exceeds an upper limit value of a battery charge power due to a further depressing of an accelerator pedal,
wherein the controller is configured to, when a ratio of a noise derived from a powertrain of the hybrid vehicle to all noises is less than a ratio of a background noise to the all noises, or when a deceleration is requested, return the engine operating point from an engine operating point on the equal power curve to an engine operating point within an operating region where power generation efficiency is high.
